(19) United States
(12) Patent Application Publication
(10) Pub. No.: US 2013/0160035 A1
(43) Pub. Date: Jun. 20, 2013

(54) OBJECTIVE LENS HOLDER, OBJECTIVE LENS DRIVING DEVICE, OPTICAL PICKUP DEVICE, AND METHOD FOR MANUFACTURING OBJECTIVE LENS DRIVING DEVICE

(71) Applicants: Shingo MATSUZAKI, Ora-gun (JP); Shunichi MORIMOTO, Ota-shi (JP); Noboru TAJIRI, Ora-gun (JP)

(72) Inventors: Shingo MATSUZAKI, Ora-gun (JP); Shunichi MORIMOTO, Ota-shi (JP); Noboru TAJIRI, Ora-gun (JP)

(21) Appl. No.: 13/711,207

(22) Filed: Dec. 11, 2012

(30) Foreign Application Priority Data
Dec. 19, 2011 (JP) 2011-277070

(51) Int. Cl. G11B 7/09; G11B 7/22; G11B 7/08

(52) U.S. Cl. CPC G11B 7/0901; G11B 7/08; G11B 7/22
USPC 720/681; 29/527.1

(57) ABSTRACT

Provided is an objective lens holder, an objective lens driving device, an optical pickup device, and a method for manufacturing an objective lens driving device, in which an adhesive for fixing coils can be collectively applied to many housings. In the present invention, to collectively apply an adhesive to OBL holders, contact portions are provided to the upper portion and the lower portion of each OBL holder. Specifically, four contact portions are provided to a +Df side end portion of the OBL holder at positions near corner portions of a principal surface portion, respectively. Further, contact portions are provided to a −Df side end portion of the OBL holder at positions overlapping with the above-described contact portions.

This application claims priority from Japanese Patent Application Number JP 2011-277070 filed on Dec. 19, 2011, the contents of which are incorporated herein by reference in its entirety.

### BACKGROUND OF THE INVENTION

1. Field of the Invention

The present invention relates to an objective lens holder to which an objective lens is attached, an objective lens driving device in which the objective lens holder is movably supported at an actuator frame, an optical pickup device, and a method for manufacturing the objective lens driving device. The present invention particularly relates to an objective lens holder to which tracking coils and focus coils are bonded using an adhesive, and the like.

2. Description of the Related Art

In an objective lens driving device in an optical head configured to optically read or write signals from or to an optical disc, an objective lens holder (called an OBL holder below) to which an objective lens is attached is movably supported at an actuator frame. In addition, the objective lens holder is provided with driving coils such as focus coils, tracking coils, and if necessary tilt coils, and the effective areas of the driving coils are placed within predetermined magnetic fields formed by magnetic circuits. With this configuration, the objective lens driving device drives the objective lens according to signals supplied to the driving coils.

The configuration of a conventional objective lens driving device is described in, for example, Japanese Patent Application Publication No. 2008-226292. Referring to FIG. 4 and a description in connection therewith of this document, various coils are arranged on outer sidewalls of a lens holder 33. Specifically, tracking coils 41a, 41b, focus coils 42a, 42b, and radial tilt coils 43a, 43b are attached to the outer sidewalls of the lens holder 33, and focus control, tracking control, and tilt control are performed in response to certain control signals inputted to these coils.

In addition, referring to FIGS. 5 and 6 of this document, focus/radial tilt bobbins 91a, 91b and tracking bobbins 92a, 92b are provided to the sidewalls of the lens holder 33. The coils described above are formed by winding conducting wires, such as enamel wires, on these bobbins.

### SUMMARY OF THE INVENTION

As is clear from FIG. 4 and its description of the above-cited document, the tracking coil 41a and others are wound on the tracking bobbin 91a and others, but nothing is disclosed as to how to bond the tracking coil 41a and others with an adhesive or the like.

Further, considering the case of mass production of optical pickup devices, supplying an adhesive to housings one by one by using supply means such as a syringe is a very troublesome step, and this might become a factor of driving up the cost of manufacturing the optical pickup devices.

The present invention has been made in consideration of the above problems, and an objective of the present invention is to provide an objective lens holder, an objective lens driving device, an optical pickup device, and a method for manufacturing the objective lens driving device, in which an adhesive for fixing coils can be efficiently applied to many housings.

An objective lens holder according to a preferred embodiment of the invention is movably supported at an objective lens driving device of an optical pickup device and configured to hold an objective lens, and comprises: a principal surface portion to which the objective lens is fixed; and a sidewall portion provided with bobbins on which tracking coils are wound. In this objective lens holder, an upper portion of the sidewall portion is provided with a first contact portion, and a lower portion of the sidewall portion is provided with a second contact portion at a position overlapping with the first contact portion in a plan view, the second contact portion being shaped to be able to come into contact with the first contact portion.

An objective lens driving device according to a preferred embodiment of the invention comprises the above-described objective lens holder and a magnetic circuit configured to generate a magnetic field generating a driving force for moving the objective lens holder in a tracking direction in response to a driving current given to a first tracking coil, a second tracking coil, a third tracking coil, and a fourth tracking coil attached to the objective lens holder.

An optical pickup device according to a preferred embodiment of the invention comprises the above-described objective lens driving device incorporated in a housing.

A method for manufacturing an objective lens driving device according to a preferred embodiment of the invention comprises the steps of: preparing the above-described objective lens holder; winding the tracking coils on the bobbins; housing focus coils inside the objective lens holder; and applying an adhesive to the focus coils and the tracking coils. In the adhesive application step, a plurality of the objective lens holders are stacked on one another in their thickness direction, and an adhesive is supplied to the coils of each of the plurality of objective lens holders while, for each adjacent ones of the objective lens holders, the first contact portion of the lower objective lens holder is in contact with the second contact portion of the lower objective lens holder.

### BRIEF DESCRIPTION OF THE DRAWINGS

FIG. 1 is a plan view of an optical pickup device according to a preferred embodiment of the invention.

FIGS. 2A and 2B are views of an objective lens driving device according to a preferred embodiment of the invention: FIG. 2A is a plan view showing the entire objective lens driving device, and FIG. 2B is a plan view showing an actuator movable unit enlarged.

FIGS. 3A and 3B are views showing an objective lens holder according to a preferred embodiment of the invention: FIG. 3A is a perspective view, seen from above, of the objective lens holder in which various coils and the like are incorporated, and FIG. 3B is a perspective view, seen from below, of the objective lens holder of FIG. 3A.

FIGS. 4A to 4C are views of the objective lens holder according to the preferred embodiment of the invention: FIG. 4A is a perspective view, seen from above, of the objective lens holder in which the various coils and the like are incorporated, FIG. 4B is a sectional view of FIG. 4A, and FIG. 4C is a sectional view showing part of FIG. 4B.

FIG. 5 is a diagram showing a method for manufacturing the objective lens driving device according to a preferred embodiment of the invention, and is a perspective view where multiple objective lens holders are stacked on one another using a jig.

FIGS. 6A and 6B are views showing the method for manufacturing the objective lens driving device according to the preferred embodiment of the invention: FIG. 6A is a perspective view, seen from above, of the stacked objective lens holders, and FIG. 6B is a perspective view, seen from below, of the stacked objective lens holders.

### DESCRIPTION OF THE INVENTION

### First Embodiment

### Optical Pickup Device

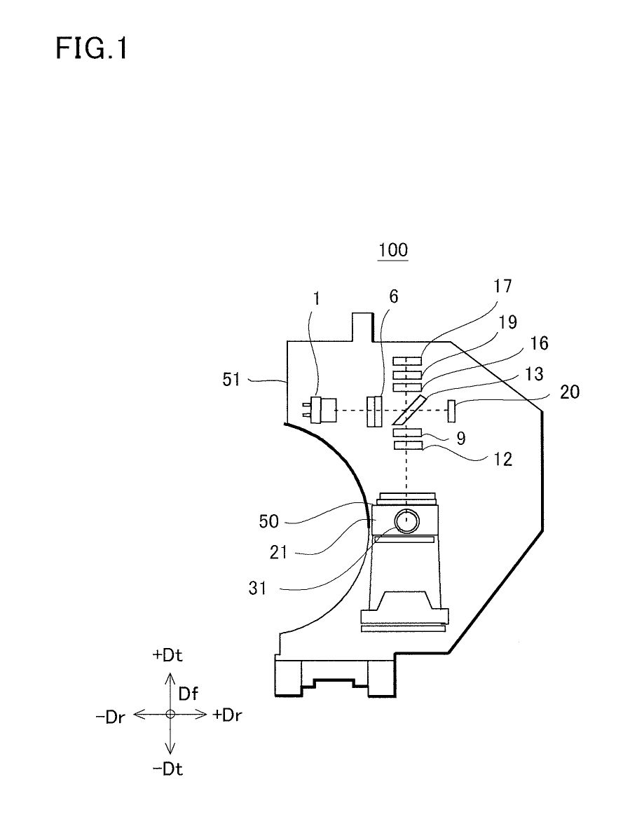

FIG. 1 is a plan view showing an overview of an optical pickup device 100 of this embodiment.

The optical pickup device 100 is configured to support optical discs in, for example, the Compact Disc (CD) format, the Digital Versatile Disc (DVD) format, and the Blu-ray Disc (BD) format. In the optical pickup device 100, an objective lens driving device 50 and various optical elements are arranged in a housing 51. An overall function of the optical pickup device 100 is to read or write information from or to an optical disc by irradiating an information recording layer of the optical disc with a laser beam in a given format and receiving the laser beam reflected from the information recording layer.

The objective lens driving device 50 (an actuator) holds an objective lens holder (called an OBL holder below) 21 while allowing it to move. An objective lens 31 which supports any one or all of the formats above is attached to the OBL holder 21.

A laser unit 1 has a laser diode which emits a laser beam in any of the above-described formats. Specifically, the laser diode emits a laser beam of a blue-violet (blue) wavelength range of 395 nm to 420 nm (e.g., a wavelength of 405 nm) suitable for BD, a laser beam of a red wavelength range of 645 nm to 675 nm (e.g., a wavelength of 650 nm) suitable for DVD, and a laser beam of an infrared wavelength range of 765 nm to 805 nm (e.g., a wavelength of 780 nm) suitable for CD.

The laser beam emitted from the laser unit 1 is split by a diffraction grating 6 into the zero-order beam, the plus first-order beam, and the minus first-order beam, and these beams are reflected by a semitransparent mirror 13. Thereafter, the beams pass through a quarter-wavelength plate 9 and a collimator lens 12, are reflected by a reflecting mirror (not shown), and are focused on the information recording layer of the optical disc. Further, part of the laser beams passes through the semitransparent mirror 13 and is detected by an FMD 20. Based on this detection, output of the laser unit 1 is adjusted. Then, a laser beam returning after being reflected by the information recording layer of the optical disc passes through the reflecting mirror, the collimator lens 12, the quarter-wavelength plate 9, and the semitransparent mirror 13. After that, a first plate 16 and a second plate 19 cancel unwanted astigmatism and add desired astigmatism. The resultant beam is detected by an optical detector (PDIC) 17. Control signals are supplied to coils in the OBL holder 21 based on a signal detected by the optical detector 17, and a control current is supplied to focus coils, tracking coils, or tilt coils. As a result, focus control, tracking control, and radial tilt control are performed. In the objective lens driving device 50 to be described later, each focus coil also has the function of the tilt coil; therefore, the tilt coil is omitted.

Note that a Dt direction shown in FIG. 1 is a tangential direction, a Dr direction is a tracking direction (i.e., the radial direction of the optical disc), and a Df direction is a focus direction. These directions intersect with one another.

### Second Embodiment

### Objective Lens Driving Device

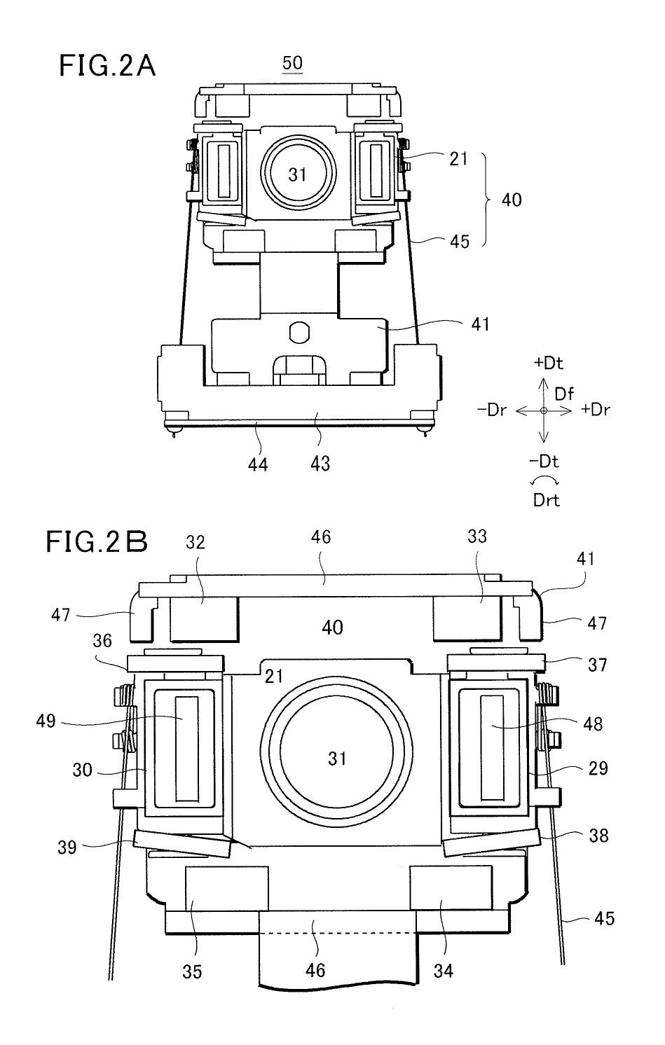

With reference to FIGS. 2A and 2B, a description is given of the objective lens driving device 50 incorporated into the optical pickup device 100 described above. FIG. 2A is a plan view of the objective lens driving device 50, and FIG. 2B is a plan view in which an actuator movable unit 40 is enlarged.

Referring to FIG. 2A, the objective lens driving device 50 (actuator) includes the actuator movable unit 40 and an actuator frame 41. The actuator movable unit 40 includes the OBL holder 21 and support wires 45. The actuator frame 41 is made of a magnetic metal material such as a silicon steel plate. Yokes to be described later are formed by partially bending the actuator frame 41 at a right angle.

The actuator movable unit 40 is elastically supported at the actuator frame 41 by the support wires 45 while being allowed to move in the focus direction (the Df direction), the tracking direction (the Dr direction), and the radial-tilt direction (the Drt direction). Each support wire 45 is secured, at one end, to a side wall of the OBL holder 21, and is secured, at the other end, to a fixture board 44 fixed to the actuator frame 41. The fixture board 44 is bonded to an auxiliary member 43 filled with a damper material for suppressing the vibration of the support wires 45, and is screwed to the actuator frame 41 together with the auxiliary member 43. As the support wires 45, for example, each sidewall of the actuator frame 41 has three wires not only to mechanically support the actuator movable unit 40 in the air, but also to serve as connection means through which a current to be supplied to the coils of the actuator movable unit 40 flows.

Referring to FIG. 2B, the actuator movable unit 40 mainly includes the OBL holder 21, the objective lens 31 fixed to the upper surface of the OBL holder 21, tracking coils 36 to 39 wound on outer surfaces of sidewall portions of the OBL holder 21, and focus coils 29 and 30 incorporated in the OBL holder 21.

Magnets 32 to 35 are placed on yokes of the actuator frame 41 which face the tracking coils 36 to 39 arranged at outer sides of the sidewall portions of the OBL holder 21. The surfaces of the magnets 52 to 54 facing the tracking coils 36 to 39 have the same polarity (e.g., N pole). The magnets 32 to 35 each generate an effective flux with respect to an effective area of a corresponding one of the tracking coils 36 to 39. With such a configuration, when a current is supplied to the tracking coils 36 to 39, the OBL holder 21 moves in the Dt direction by collaboration between magnetic fields generated by the current flow through the tracking coils 36 to 39 and magnetic circuits formed by the magnetic fields generated by the magnets 32 to 35.

Inside the OBL holder 21, the two focus coils 29 and 30 each having a winding axis in the Df direction are arranged at positions sandwiching the objective lens 31. The magnets 32 to 35 generate effective fluxes with respect to the effective areas of the focus coils 29 and 30, as well. Accordingly, when a current is supplied to the focus coils 29 and 30, the OBL holder in the Df direction by collaboration between magnetic fields generated by the current flow through the focus coils 29 and 30 and magnetic circuits formed by the magnetic fields generated by the magnets 32 to 35. Note that, in this embodiment, the OBL holder 21 is controlled as to the tilt direction (the Drt direction) by a control signal for the tilt-direction control, which is given to the focus coils 29 and 30.

A back yoke 46 is formed by bending an end portion of the actuator frame 41 at a right angle, and the magnets 32 and 33 are attached to the inner side surface of the back yoke 46. Further, both end portions, in the Dr direction, of the back yoke 46 are bent at right angles to form sub yokes 47. The back yoke 46 and the sub yokes 47 of such shapes can strengthen the effective fluxes acting effectively on the tracking coils 36 and 37, and therefore are effective in improving the sensitivity of the OBL holder 21 in the Dt direction.

Opposed yokes 48 and 49 are, like the back yoke 46 and the like, formed by bending the actuator frame 41 at a right angle, and are provided at positions inside the focus coils 29 and 30, respectively. Such arrangement of the opposed yokes 48 and 49 can strengthen the effective fluxes acting effectively on the focus coils 29 and 30 and the tracking coils 36 and 37, and therefore are effective in improving the sensitivity of the OBL holder 21 in the Df direction, the Dr direction, and the Drt direction.

### Third Embodiment

### Objective Lens Holder

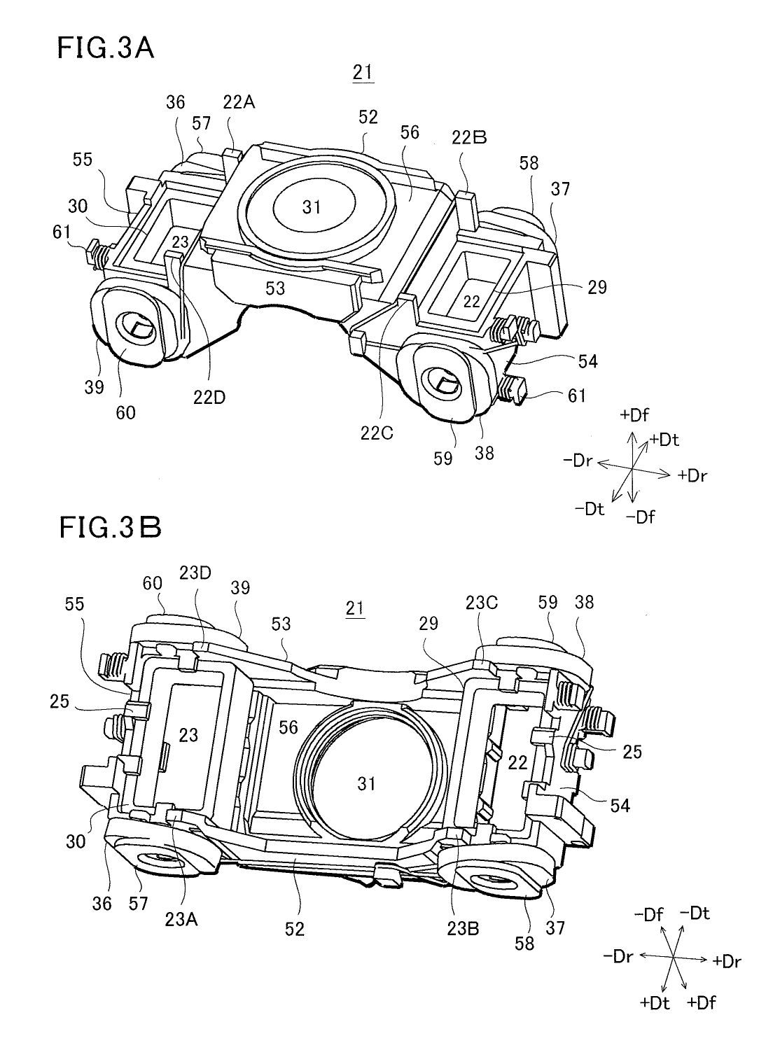

With reference to FIGS. 3A and 3B, a description is given of how the focus coils 29 and 30 and the tracking coils 36 to 39 are arranged in the OBL holder 21. FIG. 3A is a perspective view of the OBL holder 21 having the coils, and FIG. 3B is a perspective view of the OBL holder 21 shown in FIG. 3A turned upside down.

Schematically, the OBL holder 21 has a shape of a chassis provided with an opening portion at its lower portion. To be more specific, the OBL holder 21 includes a principal surface portion 56 provided with a circular opening portion to which the objective lens 31 is attached, and four continuous sidewall portions formed integrally with, and extending downward from, the peripheral portion of the principal surface portion 56. These sidewall portions include a long-side first sidewall portion 52 located at the far side in the drawing, a long-side second sidewall portion 53 located at the near side in the drawing and facing the first sidewall portion 52, a short-side third sidewall portion 54 located at the right side in the drawing, and a short-side fourth sidewall portion 55 located on the left side in the drawing. The principal surfaces of the first sidewall portion 52 and the second sidewall portion 53 are parallel to the Dr direction, and the principal surfaces of the third sidewall portion 54 and the fourth sidewall portion 54 are parallel to the Dt direction.

Bobbins 57 and 58 are provided to the outer principal surface of the first sidewall portion 52, and tracking coils 36 and 37 are wound on these bobbins 57 and 58, respectively. In addition, bobbins 59 and 60 are provided to the outer principal surface of the second sidewall portion 53, and tracking coils 38, 39 are wound on these bobbins 59 and 60, respectively. These bobbins 57 to 60 are arranged outward of the objective lens 31 in the Dr direction. The reason for this is as follows. When the OBL holder 21 is housed in a small-size optical pickup, the reflecting mirror is arranged immediately below the objective lens 31. Also, a space for the optical path to the reflecting mirror needs to be secured in an area below the center of the first sidewall portion 52 and/or the second sidewall portion 53 of the OBL holder 21. Accordingly, components such as coils cannot be housed in this area.

The tracking coils 36 to 39 wound on the corresponding bobbins are formed of a single long and thin conductive wire on which an insulating coat is formed, such as an enamel wire. An end of this conductive wire is tied around a binding portion 61 formed by making part of the third sidewall portion 54 protrude, and the other end of the conductive wire is tied around another binding portion 61 provided to the fourth sidewall portion 55. The tracking coils 36 to 39 each have a winding axis in the Dt direction, and is wound on a corresponding one of the bobbins 57 to 60, forming an overall rounded square. The tracking coils 36 to 39 are driving coils for driving the OBL holder 21 itself by a magnetic action, and the focus coils 29 and 30 to be described later have such a function, too.

Three binding portions 61 are arranged on the third sidewall portion 54. Both ends of a conductive wire, constituting the focus coil 29, on which an insulating coat is formed, such as an enamel wire, are tied around two of these binding portions 61, respectively, and an end of a conductive wire constituting the tracking coils 36 to 39 is tied around a remaining one of the bending portions 61. Similarly, three binding portions 61 are arranged on the fourth sidewall portion 55, as well. Both ends of a conductive wire constituting the focus coil 30 are tied around two of these binding portions 61, respectively, and the other end of the conductive wire constituting the tracking coils 36 to 39 is tied around a remaining one of the bending portions 61. The supporting wires 45 shown in FIG. 2A are connected to the conductive wires tied around these bending portions 61, respectively.

The focus coils 29 and 30 each have a winding axis in the Df direction, and is formed by winding a conductive wire to form an overall rounded square. The focus coils 29 and 30 are housed in the OBL holder 21. The focus coil 29 is arranged in a housing area 22 provided to an end portion of the OBL holder 21 on the third sidewall portion 54 side, and the focus coil 30 is arranged in a housing area 23 provided to an end portion of the OBL holder 21 on the fourth sidewall portion 55 side. In other words, the focus coil 29 is provided closer to the +Dr side than the objective lens 31 is, and the focus coil 30 is provided closer to the −Dr side than the objective lens 31 is. The reason why the housing areas 22 and 23 for housing the focus coils 29 and 30 are provided to the end portions outward of the outer circumferential end portion of the objective lens 31 is the same as the above-described reason for arranging the bobbins 57 to 60 at the end portions. Here, the size of each of the housing areas 22 and 23 in a plan view is equal to or slightly larger than the outer shape of the focus coil 29 and 30 to be housed therein.

Further, the top portion of the housing area 22 is not covered with the principal surface portion, and opened. Similarly, the top portion of the housing area 23, too, is an opening portion. Thus, the OBL holder 21 can move in the Df direction, with the opposed yokes 48 and 49 shown in FIG. 2B being arranged inside the focus coils 29 and 30. Further, as will be described later, in a step of applying an adhesive in the manufacturing process, multiple OBL holders 21 are stacked in their thickness direction, and a jig is inserted into the opening portions of the OBL holders 21. Thereby, the positions of the stacked OBL holders 21 can be fixed to a predetermined position.

Although it will be described later, the focus coils 29 and 30 and the tracking coils 36 to 39 are bonded to the OBL holder 21 with an adhesive supplied through the bobbins 57 to 60.

In this embodiment, in the manufacturing process to be described later, an adhesive is applied to the multiple OBL holders 21 at once. For this reason, contact portions are provided at the upper portion and the lower portion of each OBL holder 21. Thereby, when stacked on one another, the OBL holders 21 can be spaced away from one another by a predetermined distance.

Specifically, with reference to FIG. 3A, four contact portions 22A, 22B, 22C, and 22D are provided to portions near the respective corner portions of the main surface portion 56. These contact portions 22A to 22D each have a rectangular cubic shape having its long-side axis in the Df direction, and its +Df side end portion is a flat surface of a square shape. The contact portions 22A to 22D are provided as +Df side end portions of the sidewall portions.

The positions, in the Df direction, of the upper end portions of the contact portions 22A to 22D are on the same plane, which is at the same level as the principal surface 56 or shifted to the −Df side from the principal surface 56. Thus, the contact portions 22A to 22D do not protrude to the +Df side.

Here, the contact portions 22A to 22D do not necessarily have to be located near the four corners of the principal surface 56, and may be located at other positions as long as they do not interfere with the stacking of the OBL holders 21.

Referring to FIG. 3B, at a −Df side end portion of the OBL holder 21, contact portions 23A, 23B, 23C, and 23D are provided to areas overlapping with the above described contact portions 22A, 22B, 22C, 22D, respectively. The contact portions 23A to 23D are provided to the lower ends of the sidewall portions as part thereof. The contact portions 23A to 23D are portions protruding in the −Df direction from the first sidewall portion 52 and the second sidewall portion 53. The lower ends of the contact portions 23A to 23D each have a square shape in a plan view to overlap, at least partially, with the above-described contact portions 22A to 22D.

Further, the −Df side end portions of the contact portions 23A to 23D may protrude more than or may be flush with other portions of the sidewall portions.

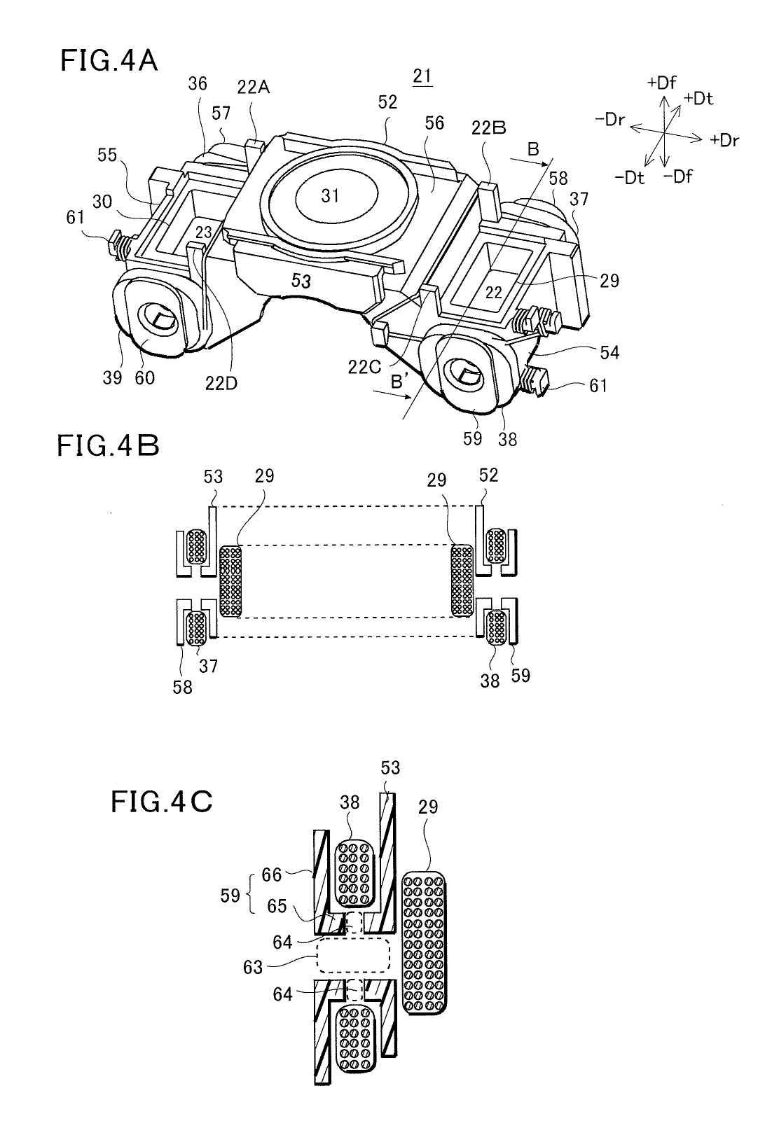

With reference to FIGS. 4A and 4C, a description is given of the configurations of the bobbins 57 to 60. FIG. 4A is a perspective view of the OBL holder 21 described above, FIG. 4B is a sectional view taken along line B-B′ in FIG. 4A, and FIG. 4C is a sectional view of the bobbin 59 enlarged.

Referring to FIG. 4B, the tracking coil 37 is wound on the flanged bobbin 58 protruding outward from the first sidewall portion 52 of the OBL holder 21. Similarly, the tracking coil 38 is wound on the flanged bobbin 59 protruding outward from the second sidewall portion 53. Further, the focus coil 29 is arranged between the inner principal surfaces of the first sidewall portion 52 and the second sidewall portion 53, or more specifically between positions where the bobbins 58 and 59 are provided. Such a configuration is also employed by the bobbins 57 and 60, the tracking coils 36 and 39, and the focus coil 30 that are provided to the other end portion of the OBL holder 21.

The tracking coils 36 to 39 and the focus coils 29 and 30 described above are impregnated with an adhesive such as an epoxy resin. This can prevent the conductive wires constituting the coils from being deformed due to a magnetic force acting on them when the optical pickup device is being operated. Furthermore, when the tracking coils and the focus coils are fixed to the OBL holder 21 with an adhesive, movement and separation of the coils when the optical pickup device is operated are prevented.

With reference to FIG. 4C, the configuration of the bobbin 59 is described. The bobbin 59 has a cylindrical pipe-shaped portion 65 protruding outward from the second sidewall portion 53, and a flange portion 66 formed by extending the outer end portion of the pipe-shaped portion 65 in its radial direction. The pipe-shaped portion 65 and the flange portion 66 constituting the bobbin 59 each have the same thickness as the OBL holder 21. The pipe-shaped portion 65 may have a shape other than the cylindrical shape having a circular cross section, and for example, may have a cross section of an oval or a rounded rectangular which is long in the vertical direction in the drawing. The rest of the bobbins, namely, the bobbins 57, 58, and 60 have the same configuration as the bobbin 59 described above.

A communicating hole 63 through which the inside of the OBL holder 21 communicates with the outside thereof is provided inside the pipe-shaped portion 65, and through-holes 64 are provided, partially penetrating the upper portion and the lower portion of the pipe-shaped portion 65, respectively. As will be described later, the communicating hole 63 is used as a channel for supplying an adhesive to the focus coil 29, and the through-holes 64 are used as channels for supplying an adhesive to the tracking coil 38.

### Fourth Embodiment

### Method for Manufacturing the Objective Lens Driving Device

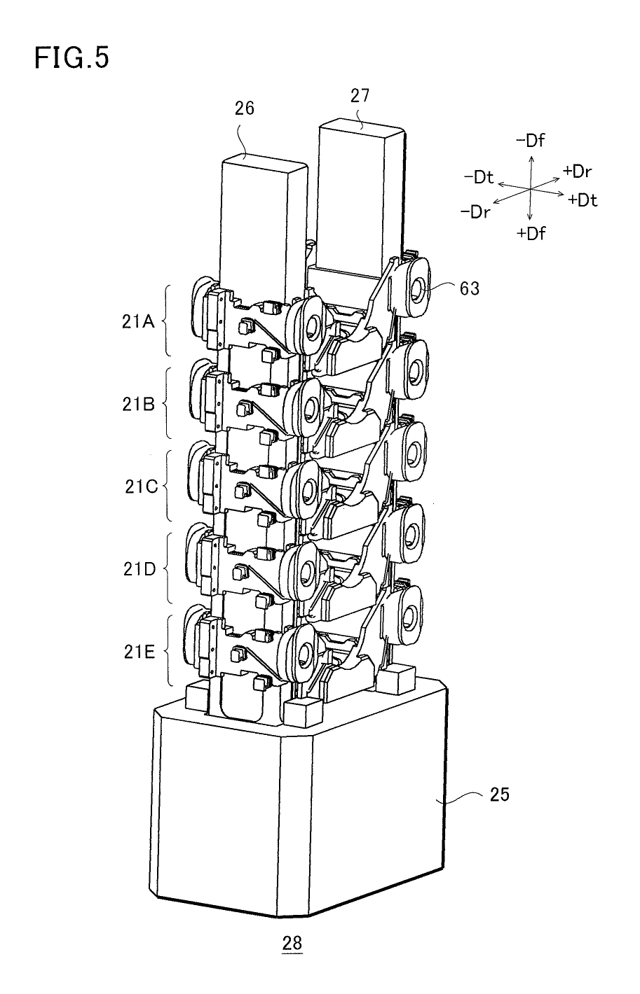

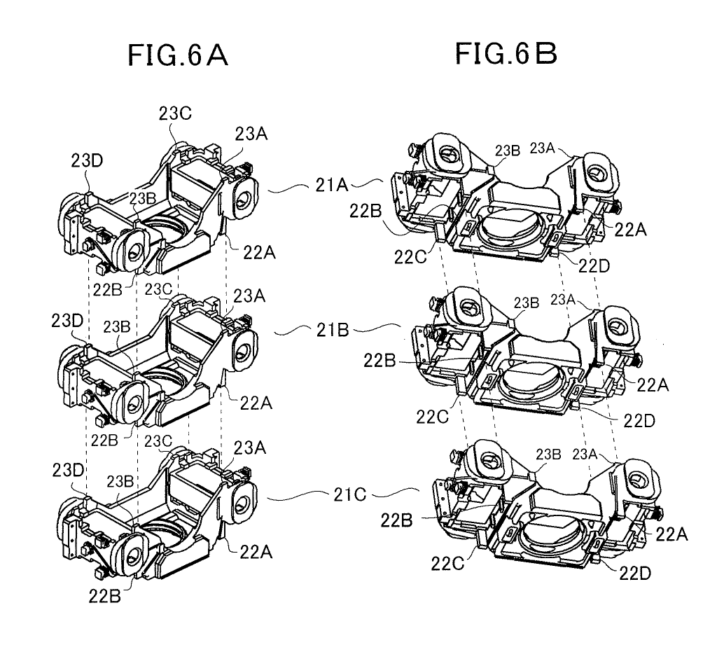

With reference to FIGS. 5, 6A, and 6B as well as the drawings referred to above, a description is given of a method for manufacturing the objective lens driving device having the above-described configuration.

Referring to FIG. 3A, first, the OBL holders 21 having the above-described shape are prepared. The OBL holders 21 are each formed by injecting a resin material, such as a liquid crystal polymer, into the cavity of a mold. As already described, the OBL holder 21 has four sidewall portions, and the bobbins 57 to 60, on which the tracking coils are wound, are integrally provided to the first sidewall portion 52 and the second sidewall portion 53.

Next, the tracking coils 36 to 39 are formed by winding a conductive wire on the bobbins 57 to 60. The tracking coils 36 to 39 are formed of a single conductive wire, and are wound on the bobbins 59, 58, 57, and 60, in this order, by an automated device. An end of the conductive wire forming the tracking coils 36 to 39 is tied around the bending portion 61 provided to the third sidewall portion 54. The other end of the conductive wire is tied around the bending portion 61 provided to the fourth sidewall portion 55.

Next, as shown in FIG. 3B, the focus coils 29 and 30 are housed in the OBL holder 21. Specifically, the focus coil 29 is housed in the housing area 22, and the focus coil 30 is housed in the housing area 23.

Referring to FIGS. 5, 6A, and 6B, next, an adhesive is supplied to fix the focus coils 29 and 30 to the OBL holder 21.

Referring to FIG. 5, in this step, the adhesive is supplied to multiple OBL holders 21A and others with the OBL holders 21A and others being stacked in their thickness direction. Here, five OBL holders 21A to 21E are stacked in this order from above downwards.

The OBL holders 21A to 21E are stacked stably in the following way. The contact portions 22A to 22D provided to the upper portion of each of the OBL holders 21A to 21E are in contact with the contact portions 23A to 23D provided to the lower portion of each of the OBL holders 21A to 21E, and adjacent ones of the OBL holders are not in contact with each other and spaced away from each other by a predetermined distance, except for their contact portions 22A to 22D and contact portions 23A to 23D. In other words, main components of the OBL holder, such as the objective lens 31, the focus coils 29 and 30, and the tracking coils 36 to 39, do not touch adjacent OBL holders and are thus protected.

Further, in this step, the OBL holders 21A and others are not simply stacked, but a jig 28 is used in this stacking. The jig 28 is formed by molding metal, such as stainless steel, into a predetermined shape, and includes a support portion 25 supporting the whole and rod-shaped penetration portions 26 and 27 located on the upper portion of the support portion 25. The cross sectional shapes of the penetration portions 26 and 27 are the same as or slightly smaller than the inner-wall shapes of the focus coils 29 and 30 shown in FIG. 3A, respectively.

As described with reference to FIG. 3A, in the OBL holder 21, portions where the focus coils 29 and 30 are arranged are not covered with the principal surface from above, i.e., opening portions are formed. Accordingly, the penetration portions 26 and 27 are inserted through the insides of the focus coils 29 and 30 of the OBL holder 21A and others at the portions where the opening portions are formed. Thereby, the OBL holders 21A to 21E are stacked with the penetration portions 26 and 27 being inserted therethrough, so that the OBL holders 21A to 21E have predetermined positional relations in the Dr direction, the Dt direction, and the Df direction.

As a result, the communicating holes 63 of the OBL holders align with each other in the Df direction at predetermined intervals. By using means such as a syringe for adhesive supply, an adhesive can be easily supplied to the communicating holes 63 continuously.

With reference to FIGS. 6A and 6B, a detailed description is given of how the OBL holders are stacked in the above-described state. Here, only the OBL holders 21A, 21B, and 21C are shown, and they are spaced from each other so that their positional relations can be easily understood. FIG. 6A is a perspective view of the spaced-apart OBL holders seen from above, and FIG. 6B is a perspective view thereof seen from below. Although the OBL holders are stacked with their principal surface portions where the objective lenses are attached facing downward, they may be stacked upside down.

Referring to FIG. 6B, the uppermost OBL holder 21A has the above-described contact portions 22A, 22B, 22C, and 22D at its lower portion. Referring to FIG. 6A, the contact portions 22A to 22D of the OBL holder 21A overlap, in position, with the contact portions 23A to 23D of the OBL holder 21B stacked at the second stage from the top. Accordingly, when the OBL holder 21A is stacked on the OBL holder 21B, the contact portions 22A to 22D provided to the lower portion of the OBL holder 21A come into contact with the contact portions 23A to 23D provided to the upper portion of the OBL holder 21B, so that the OBL holders 21A and 21B have a positional relation at a predetermined distance in the vertical direction.

This also applies to the OBL holder 21B at the second stage and the OBL holder 21C at the third stage.

Subsequently, as shown in FIG. 5, a liquid adhesive is continuously supplied to the communicating holes 63 of the respective OBL holders 21A to 21E stacked on one another with the jig 28.

Referring to FIG. 4C, the adhesive supplied to the communicating hole 63 of the bobbin 59 reaches the focus coil 29, thereby attaching the focus coil 29 to the inner wall of the OBL holder 21. In addition, since the through-holes 64 are formed in the pipe-shaped portion 65 of the bobbin 59, the supplied adhesive also enters the tracking coil 38 through the through-holes 64 to attach the tracking coil 38 to the bobbin 59. This also applies to the other bobbins of the OBL holder 21.

Referring to FIG. 5, after completion of the supply and solidification of the adhesive, the jig 28 is withdrawn from the OBL holders.

With the steps described above, the OBL holder 21 having a configuration shown in FIG. 3 is manufactured. In addition, referring to FIG. 2, the OBL holder 21 is fixed to the actuator frame 41 through the support wires 45. Thus, the objective lens driving device 50 is manufactured. Furthermore, referring to FIG. 1, the objective lens deriving device 50 having such a configuration is incorporated into the housing 51 along with the other optical elements. Thus, the optical pickup device 100 is manufactured.

In the present invention, the first contact portion is provided to the upper portion of the objective lens holder, and the second contact portion is provided to the lower portion thereof at a position overlapping with the first contact portion. Then, in the step of supplying an adhesive to the coils incorporated in the objective lens holder, multiple objective lens holders are stacked with the first contact portion at the lower portion of the objective lens holder being in contact with the contact portion at the upper portion of an adjacent objective lens holder. Thereby, the multiple objective lenses can be aligned with desired positional relations therebetween. As a result, with the objective lens holders being stacked on one another, an adhesive can be efficiently supplied to the coils incorporated in the objective lens holders.

What is claimed is:

1. An objective lens holder movably supported at an objective lens driving device of an optical pickup device and configured to hold an objective lens, the objective lens holder comprising:
a principal surface portion to which the objective lens is fixed; and
a sidewall portion provided with bobbins on which tracking coils are wound, wherein
an upper portion of the sidewall portion is provided with a first contact portion, and
a lower portion of the sidewall portion is provided with a second contact portion at a position overlapping with the first contact portion in a plan view, the second contact portion being shaped to be able to come into contact with the first contact portion.

2. The objective lens holder according to claim 1, wherein
a plurality of the first contact portions are provided,
upper end portions of the respective first contact portions are located on a same plane,
a plurality of the second contact portions are provided, and
lower end portions of the respective second contact portions are located on a same plane.

3. The objective lens holder according to claim 1, wherein
an upper end portion of the first contact portion and a lower end portion of the second contact portion are each a flat surface.

4. The objective lens holder according to claim 1, wherein
four first contact portions are provided near corner portions of the principal surface portion, respectively.

5. An objective lens driving device comprising:
the objective lens holder according to claim 1; and
a magnetic circuit configured to generate a magnetic field generating a driving force for moving the objective lens holder in a tracking direction in response to driving currents given to a first tracking coil, a second tracking coil, a third tracking coil, and a fourth tracking coil attached to the objective lens holder.

6. An optical pickup device comprising the objective lens driving device according to claim 5 incorporated in a housing.

7. A method for manufacturing an objective lens driving device, comprising the steps of:
preparing the objective lens holder according to claim 1;
winding the tracking coils on the bobbins;
housing focus coils inside the objective lens holder; and
applying an adhesive to the focus coils and the tracking coils, wherein
in the adhesive application step,
a plurality of the objective lens holders are stacked on one another in their thickness direction, and
the adhesive is supplied to the coils of each of a plurality of the objective lens holders that are stacked on one another in their thickness direction in such a manner that each adjacent two objective lens holders have the first contact portion of the lower one being in contact with the second contract portion of the upper one.

8. The method for manufacturing an objective lens driving device according to claim 7, wherein
the objective lens holders are each provided with, at its both end portions, housing areas which are configured to house the focus coils and whose upper portion and lower portion are open, and
the plurality of objective lens holders are fixed by making a jig penetrate the housing areas and the focus coils provided at both the end portions of the plurality of objective lens holders.

9. The method for manufacturing an objective lens driving device according to claim 7, wherein
each of the bobbins has a pipe-shaped portion and a communicating hole penetrating the pipe-shaped portion in its thickness direction, and
the adhesive is supplied to the focus coils through the communicating hole.
